(19) United States
(12) Patent Application Publication
(10) Pub. No.: US 2026/0031075 A1
(43) Pub. Date: Jan. 29, 2026

(54) Hands-Free Motorized Singing Bowl Arrangement

(71) Applicant: Christopher Lamont, Toronto (CA)

(72) Inventor: Christopher Lamont, Toronto (CA)

(21) Appl. No.: 18/781,245

(22) Filed: Jul. 23, 2024

(51) Int. Cl. G10K 1/072; G10G 5/00

(52) U.S. Cl. CPC G10K 1/072; G10G 5/005

(57) ABSTRACT

A hands-free motorized singing bowl arrangement includes a base structure, an arm structure, a head structure, a motor, a telescopic arm, and a mallet. The motor includes an axle that is positioned to project out of the head structure toward the base structure. The telescopic arm is pivotably connected to the axle. The mallet is mounted on the telescopic arm. The motor rotates the axle and the telescopic arm and thereby move the mallet along a rim portion of a singing bowl to play the singing bowl. The telescopic arm is adjustable in length and angular position with respect to the axle to permit a user to position the mallet against rim portions of singing bowls of different sizes and dimensions.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to singing bowls and more particularly pertains to a new hands-free motorized singing bowl arrangement for automatically playing a singing bowl. Singing bowls are pleasant-sounding devices that make musical sounds by resonance caused by running a device called a mallet along a rim portion of the singing bowl. Unfortunately, many people do not know how to play a singing bowl, or they wish to enjoy its sounds while doing other activities, such as exercise, meditation, or any other activity around the house, at the gym or spa, or even at the workplace. It therefore would be advantageous to have a device that automatically plays a singing bowl reliably and with a high-quality sound.

### (2) Description of Related Art Including Information Disclosed Under 37 CFR 1.97 and 1.98

The prior art relates to singing bowls and music devices. The prior art, as best understood, does not disclose hands-free motorized singing bowl arrangement that has an adjustable telescopic arm that supports the mallet to permit a user to position the mallet against rim portions of singing bowls of different sizes and dimensions.

### BRIEF SUMMARY OF THE INVENTION

An embodiment of the disclosure meets the needs presented above in a hands-free motorized singing bowl arrangement generally comprising a base structure, an arm structure, a head structure, a motor, a telescopic arm, and a mallet. The base structure is designed to support a singing bowl. The arm structure extends from and transverse to the base structure. The head structure extends from and transverse to the arm structure. The arm structure is designed to support the head structure above the base structure and at distance sufficient to permit placement of a singing bowl between the base structure and the head structure. The motor is positioned in the head structure. The motor includes an axle that is positioned to project out of the head structure toward the base structure. The telescopic arm is pivotably connected to the axle. The mallet is elongated and mounted coaxially on the telescopic arm. The mallet is designed to be placed in contact with a rim portion of a singing bowl. The motor is designed to rotate the axle and the telescopic arm and thereby move the mallet along a rim portion of a singing bowl to play the singing bowl. The telescopic arm is designed to be adjusted in length and angular position with respect to the axle to permit a user to position the mallet against rim portions of singing bowls of different sizes and dimensions.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a hands-free motorized singing bowl arrangement according to an embodiment of the disclosure.

FIG. 2 is a bottom perspective view of an embodiment of the disclosure.

FIG. 3 is a side view of an embodiment of the disclosure.

FIG. 4 is a close-up view of a portion of an embodiment of the disclosure.

FIG. 5 is a side view of an embodiment of the disclosure.

FIG. 6 is a cross-sectional view of a portion of an embodiment of the disclosure.

FIG. 7 is a view of an embodiment of the disclosure in use.

FIG. 8 is a top perspective view of an embodiment of the disclosure.

FIG. 9 is a side view of an embodiment of the disclosure.

### DETAILED DESCRIPTION OF THE INVENTION

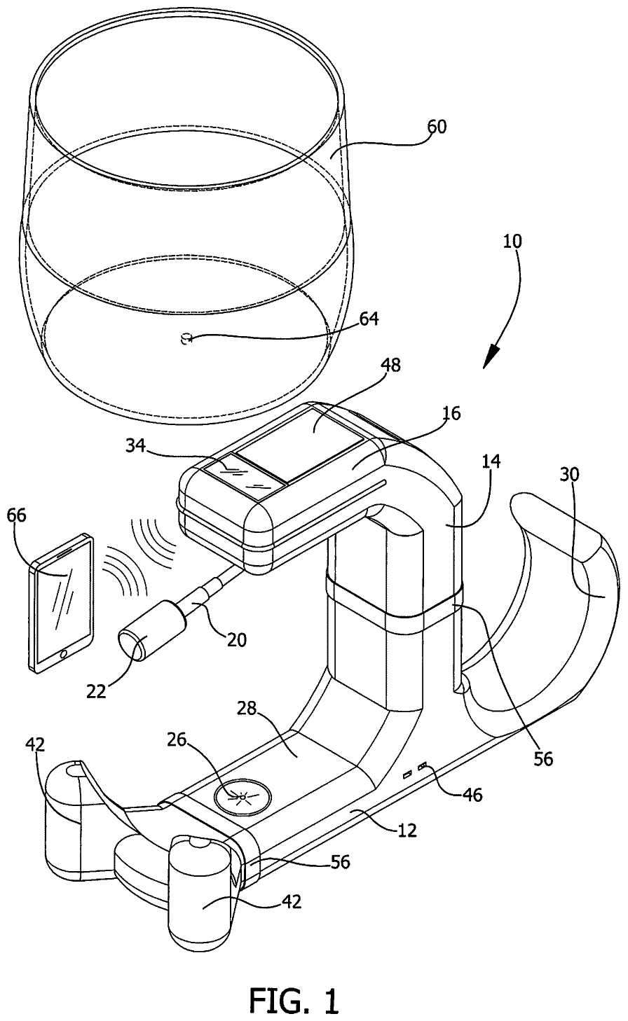

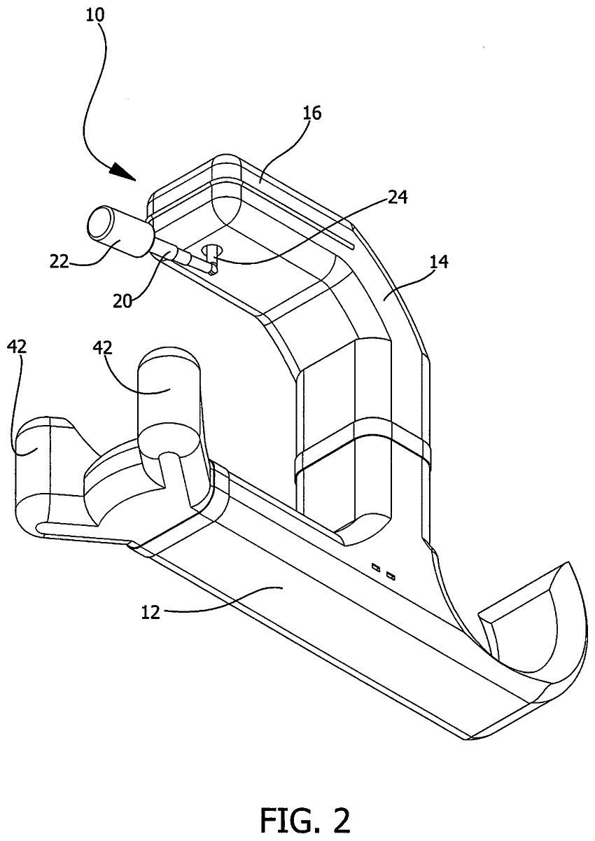

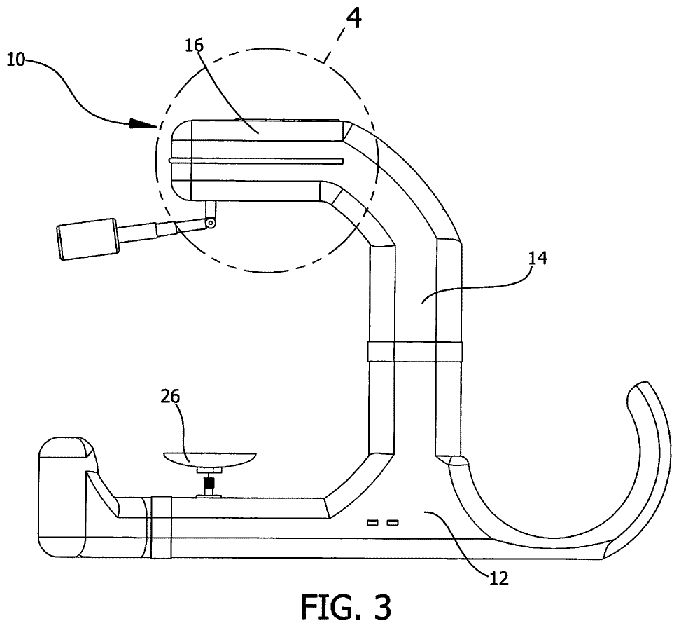

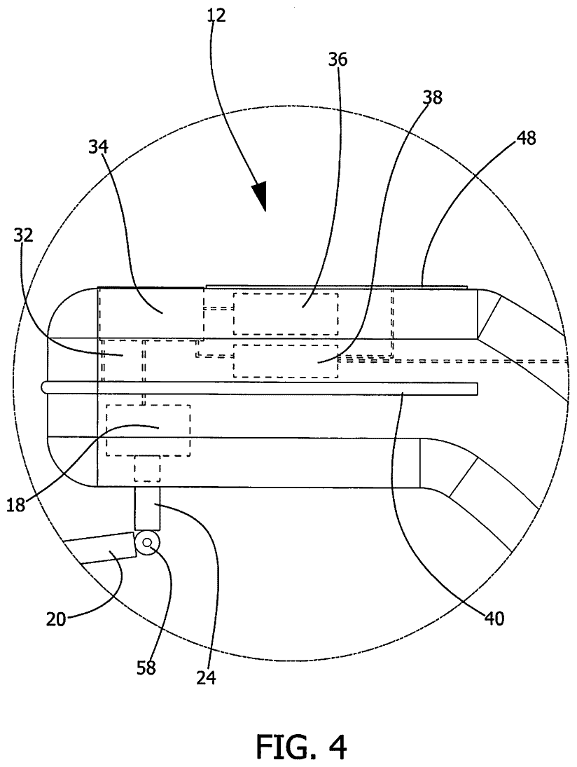

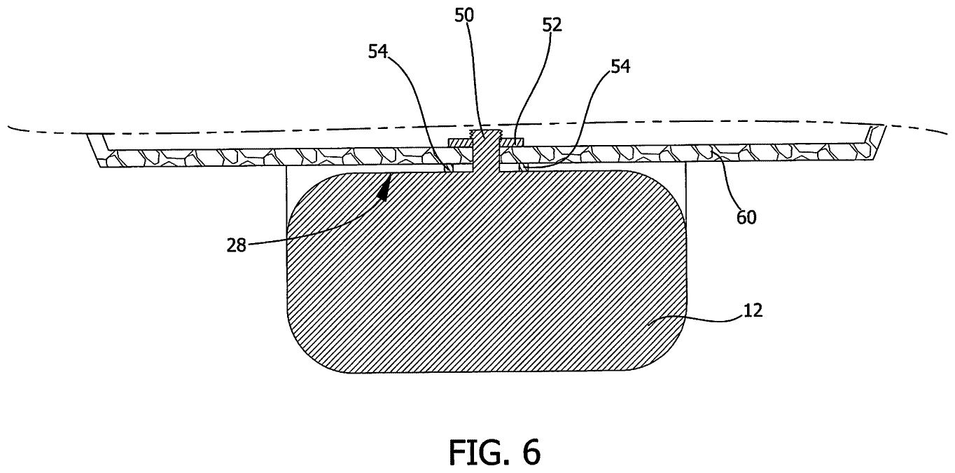

With reference now to the drawings, and in particular to FIGS. 1 through 9 thereof, a new hands-free motorized singing bowl arrangement embodying the principles and concepts of an embodiment of the disclosure and generally designated by the reference numeral 10 will be described.

As best illustrated in FIGS. 1 through 9, the hands-free motorized singing bowl arrangement 10 generally comprises a base structure 12, an arm structure 14, a head structure 16, a motor 18, a telescopic arm 20, and a mallet 22. The base structure 12 is designed to support a singing bowl 60. The arm structure 14 extends from and transverse to the base structure 12. The head structure 16 extends from and transverse to the arm structure 14. The arm structure 14 is designed to support the head structure 16 above the base structure 12 and at distance sufficient to permit placement of a singing bowl 60 between the base structure 12 and the head structure 16. The motor 18 is positioned in the head structure 16. The motor 18 includes an axle 24 that is positioned to project out of the head structure 16 toward the base structure 12. The telescopic arm 20 is pivotably connected to the axle 24. The mallet 22 is elongated and mounted coaxially on the telescopic arm 20. The mallet 22 is designed to be placed in contact with a rim portion 62 of a singing bowl 60. The motor 18 is designed to rotate the axle 24 and the telescopic arm 20 and thereby move the mallet 22 along a rim portion 62 of a singing bowl 60 to play the singing bowl 60. The telescopic arm 20 is designed to be adjusted in length and angular position with respect to the axle 24 to permit a user to position the mallet 22 against rim portions of singing bowls of different sizes and dimensions. It should be noted that the phrase “singing bowl” as used in the application should be understood as referring to any type of singing bowl.

In accordance with at least one possible embodiment, the telescopic arm 20 is spring loaded, via spring hinge 58, to maintain the mallet 22 in constant contact with a rim portion 62 of a singing bowl 60 with a consistent pressing force throughout movement of the mallet 22 along a rim portion 62 of a singing bowl 60.

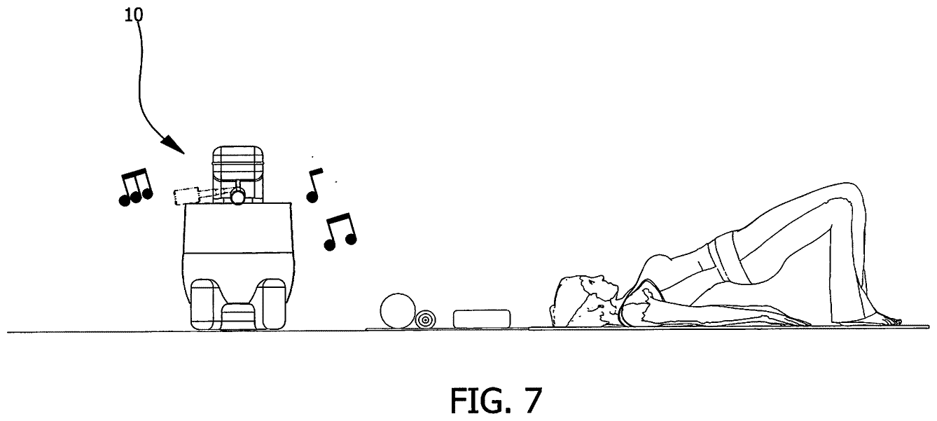

In accordance with at least one possible embodiment, the hands-free motorized singing bowl arrangement 10 further includes a customized singing bowl 60 (see FIG. 1) designed to be detachably connected to the base structure 12, as well as a suction cup 26 (see FIG. 7) designed to be detachably connected to the base structure 12 to hold a standard singing bowl on the base structure 12. The base structure 12 includes a flat surface 28 disposed to face toward said head structure 16. The customized singing bowl 60 includes an aperture 64 in a bottom surface thereof. The suction cup 26 includes an aperture therein. The base structure 12 includes a securing bolt 44 projecting from said flat surface 28 and essentially aligned with said axle 24. The securing bolt 44 comprises a threaded shaft 50 and a securing nut 52 configured to be screwed onto the threaded shaft 50. The base structure 12 includes a support projection 54 that surrounds the threaded shaft 50 and projects a short distance from the flat surface 28. The securing nut 52 and the support projection 54 together clamp and hold the customized singing bowl 60 or the suction cup 26, depending on which one is installed by the user. The base structure 12 is configured to support the customized singing bowl 60 and the suction cup 26 a distance from the flat surface 28 such that the customized singing bowl 60 or a standard singing bowl is supported with a single point of contact to maximize resonance length and volume upon playing. To further explain, if a singing bowl is resting on the flat surface 28, there is substantial surface contact, which could result in a dampening of vibrations and the resulting resonance and sound. By supporting the singing bowl on the support projection 54, with or without the suction cup 26, the singing bowl is essentially held freely on one small contact point, such that any dampening effects are minimized, and thus the resulting sound is louder and longer in duration.

In accordance with at least one possible embodiment, the arm structure 14 is essentially curved in the form of an arc substantially similar to a curved side of a singing bowl. The arm structure comprises a telescoping section 56 configured to permit adjustment of the vertical position of the head structure 16 to permit a user to increase or decrease the space between the head structure 16 and the base structure 12 to accommodate singing bowls of different heights.

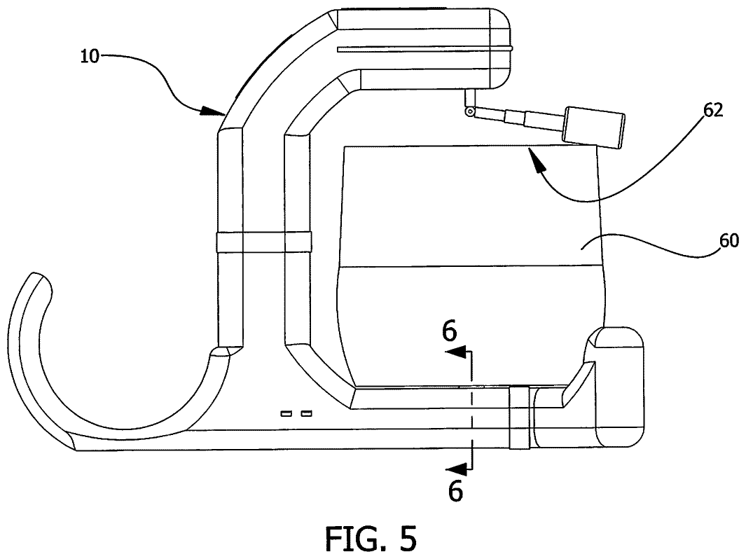

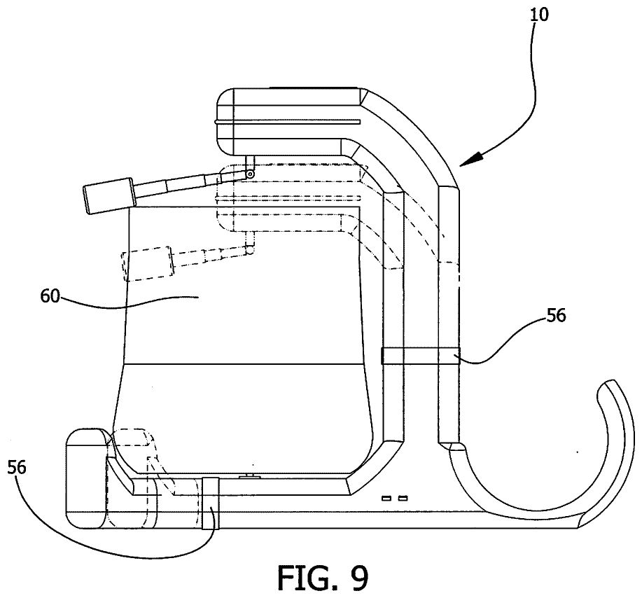

In accordance with at least one possible embodiment, the base structure 12 includes two curved shoulder portions 42 positioned opposite the arm structure 14 and designed to cradle or substantially follow a curved outer surface of a singing bowl 60. The base structure 12 comprises a telescoping section 56 positioned between the securing bolt 44 and the two curved shoulder portions 42 and configured to permit adjustment of the horizontal position of the two curved shoulder portions 42 to permit a user to increase or decrease the space between the arm structure 14 and the two curved shoulder portions 42 to accommodate singing bowls of different widths. FIG. 9 shows the vertical and horizontal adjustment for a larger singing bowl 60 than the singing bowl in FIG. 5.

In accordance with at least one possible embodiment, the customized singing bowl 60 is made of metal, glass, or crystal. It should be understood that the hands-free motorized singing bowl arrangement 10 could include any number of customized singing bowls 60 so the user can interchange them as desired.

In accordance with at least one possible embodiment, the hands-free motorized singing bowl arrangement 10 further includes a control processor 32 positioned in the head structure 16. The control processor 32 is operatively connected to the motor 18 to control the operation thereof.

In accordance with at least one possible embodiment, the hands-free motorized singing bowl arrangement 10 further includes a digital control screen 34 and/or manual control buttons mounted in the head structure 16 and designed to permit a user to view operating settings and/or select operating settings. Such operating settings include actuation of the motor 18, speed of rotation of the motor 18, and duration of rotation of the axle 24 in accordance with a preset program or user-selected settings.

In accordance with at least one possible embodiment, the hands-free motorized singing bowl arrangement 10 further includes a transceiver 36 designed to receive input commands wirelessly from an app on a mobile device 66 or a remote control.

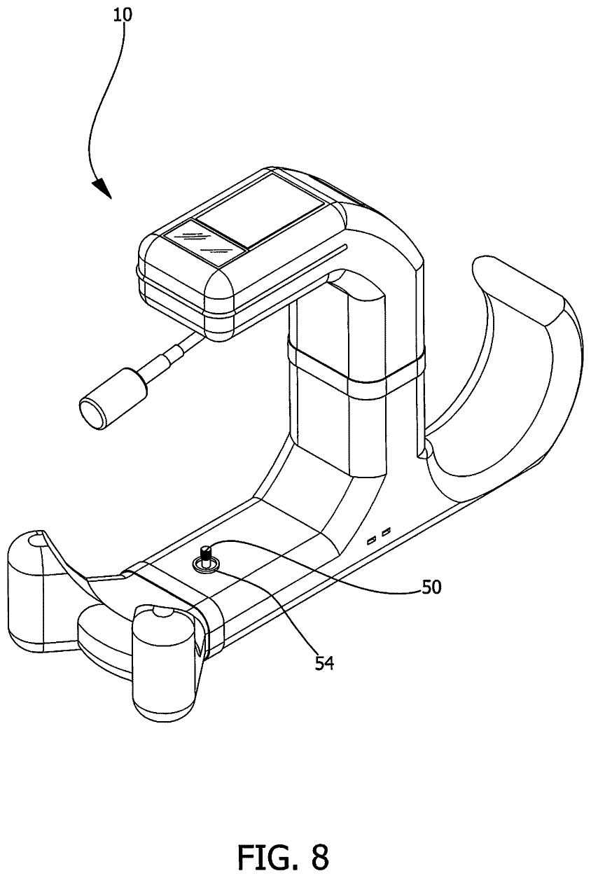

In accordance with at least one possible embodiment, the hands-free motorized singing bowl arrangement 10 further includes a power supply. The power supply can be rechargeable batteries 38 and a USB power plug 46 positioned in the head structure 16, arm structure 14, or the base structure 12, with an example shown in FIG. 1. Alternatively, the power supply can be solar panels 48 positioned on the head structure 16 or the arm structure 14, with an example shown in FIG. 8. The rechargeable batteries 38 could be combined with the solar panels 48.

In accordance with at least one possible embodiment, the hands-free motorized singing bowl arrangement 10 further includes an LED light arrangement 40 positioned in at least one of the head structure 16, the arm structure 14, and the base structure 12. The light arrangement 40 is designed to emit aesthetic and/or multi-colored lights.

In accordance with at least one possible embodiment, the mallet 22 is removably attached to the telescopic arm 20 to permit replacement or exchanging of the mallet 22 with another mallet of a different size or material. The mallet 22 includes a contact layer designed to contact a rim portion 62 of a singing bowl 60, which contact layer is made of rubber, leather, or silicone material. The base structure 12 includes a rear cradle 30 configured to hold the mallet 22 and/or additional mallets and/or an instruction manual.

In order to use the hands-free motorized singing bowl arrangement 10, the user merely places a singing bowl 60, either a standard singing bowl or the customized singing bowl 60, in position beneath the head structure 16. For the customized singing bowl 60, it is placed onto the support projection 54 with the threaded shaft 50 passing through the aperture 64, and the user then screws the securing nut 52 onto the threaded shaft 50 to clamp it in place. For other singing bowls, the suction cup 26 is secured in the same way, and then the singing bowl is placed in the suction cup 26. The user can adjust the telescopic arm 20 as needed to place the mallet 22 on the rim portion 62 of the singing bowl 60, as well as adjust the telescoping sections 56 as needed. The user can then activate the device, either according to a preset program or selected operating settings, and the mallet 22 is then automatically moved around the rim portion 62 to play the singing bowl 60. The user is then free to exercise or meditate or do other activities with the singing bowl 60 playing in the background, as shown in FIG. 7.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hands-free motorized singing bowl arrangement comprising:
a base structure being configured to support a singing bowl;
an arm structure extending from and transverse to said base structure;
a head structure extending from and transverse to said arm structure;
said arm structure being configured to support said head structure above and a distance from said base structure sufficient to permit placement of a singing bowl between said base structure and said head structure;
a motor being disposed in said head structure;
said motor comprising an axle being disposed to project out of said head structure toward said base structure;
a telescopic arm being pivotably connected to said axle;
a mallet being elongated and mounted coaxially on said telescopic arm;
said mallet being configured to be placed in contact with a rim portion of a singing bowl;
said motor being configured to rotate said axle and said telescopic arm and thereby move said mallet along a rim portion of a singing bowl to play the singing bowl; and
said telescopic arm being configured to be adjusted in length and angular position with respect to said axle to permit a user to position said mallet against rim portions of singing bowls of different sizes and dimensions.

2. The hands-free motorized singing bowl arrangement of claim 1, wherein said telescopic arm is spring loaded to maintain said mallet in constant contact with a rim portion of a singing bowl with a consistent pressing force throughout movement of said mallet along a rim portion of a singing bowl.

3. The hands-free motorized singing bowl arrangement of claim 2, further comprising a customized singing bowl configured to be detachably connected to said base structure, and a suction cup configured to be detachably connected to said base structure to hold a standard singing bowl on said base structure, wherein:
said base structure comprises a flat surface disposed to face toward said head structure;
said customized singing bowl comprises an aperture in a bottom surface thereof;
said suction cup comprises an aperture therein;
said base structure comprises a securing bolt projecting from said flat surface and essentially aligned with said axle;
said securing bolt comprises a threaded shaft and a securing nut configured to be screwed onto said threaded shaft;
said base structure comprises a support projection disposed to surround said threaded shaft and project a short distance from said flat surface;
said securing nut and said support projection are configured and disposed to clamp and hold said customized singing bowl or said suction cup; and
said base structure is configured to support said customized singing bowl and said suction cup a distance from said flat surface such that said customized singing bowl or a standard singing bowl is supported with a single point of contact to maximize resonance length and volume upon playing.

4. The hands-free motorized singing bowl arrangement of claim 3, wherein:
said arm structure is essentially curved in the form of an arc substantially similar to a curved side of a singing bowl; and
said arm structure comprises a telescoping section configured to permit adjustment of the vertical position of said head structure to permit a user to increase or decrease the space between said head structure and said base structure to accommodate singing bowls of different heights.

5. The hands-free motorized singing bowl arrangement of claim 4, wherein:
said base structure comprises two curved shoulder portions disposed opposite said arm structure and configured to cradle or substantially follow a curved outer surface of a singing bowl; and
said base structure comprises a telescoping section disposed between said securing bolt and said two curved shoulder portions and configured to permit adjustment of the horizontal position of said two curved shoulder portions to permit a user to increase or decrease the space between said arm structure and said two curved shoulder portions to accommodate singing bowls of different widths.

6. The hands-free motorized singing bowl arrangement of claim 5, wherein said customized singing bowl comprises metal, glass, or crystal.

7. The hands-free motorized singing bowl arrangement of claim 6, further comprising a control processor disposed in said head structure wherein said control processor is operatively connected to said motor to control the operation thereof.

8. The hands-free motorized singing bowl arrangement of claim 7, further comprising a digital control screen and/or manual control buttons mounted in said head structure and configured to permit a user to view operating settings and/or select operating settings comprising actuation of said motor, speed of rotation of said motor, and duration of rotation of said axle in accordance with a preset program or user-selected settings.

9. The hands-free motorized singing bowl arrangement of claim 8, further comprising a transceiver configured to receive input commands wirelessly from an app on a mobile device or a remote control.

10. The hands-free motorized singing bowl arrangement of claim 9, further comprising a power supply, wherein said power supply comprises at least one of:
rechargeable batteries and a USB power plug disposed in said head structure, arm structure, or said base structure; and
solar panels disposed on said head structure or said arm structure.

11. The hands-free motorized singing bowl arrangement of claim 10, further comprising an LED light arrangement disposed in at least one of said head structure, said arm structure, and said base structure and configured to emit aesthetic and/or multi-colored lights.

12. The hands-free motorized singing bowl arrangement of claim 10, wherein:
said mallet is removably attached to said telescopic arm to permit replacement or exchanging of said mallet with another mallet of a different size or material;
said mallet comprises a contact layer configured to contact a rim portion of a singing bowl and comprising rubber, leather, or silicone material; and
said base structure comprises a rear cradle configured to hold said mallet and/or additional mallets and/or an instruction manual.

13. The hands-free motorized singing bowl arrangement of claim 2, further comprising a customized singing bowl configured to be detachably connected to said base structure, and a suction cup configured to be detachably connected to said base structure to hold a standard singing bowl on said base structure, wherein:
said base structure comprises a flat surface disposed to face toward said head structure;
said customized singing bowl comprises an aperture in a bottom surface thereof;
said suction cup comprises an aperture therein;
said base structure comprises a securing bolt projecting from said flat surface and essentially aligned with said axle;
said securing bolt comprises a threaded shaft and a securing nut configured to be screwed onto said threaded shaft;
said base structure comprises a support projection disposed to surround said threaded shaft and project a short distance from said flat surface;
said securing nut and said support projection are configured and disposed to clamp and hold said customized singing bowl or said suction cup; and
said base structure is configured to support said customized singing bowl and said suction cup a distance from said flat surface such that said customized singing bowl or a standard singing bowl is supported with a single point of contact to maximize resonance length and volume upon playing.

14. The hands-free motorized singing bowl arrangement of claim 13, wherein:
said arm structure is essentially curved in the form of an arc substantially similar to a curved side of a singing bowl; and
said arm structure comprises a telescoping section configured to permit adjustment of the vertical position of said head structure to permit a user to increase or decrease the space between said head structure and said base structure to accommodate singing bowls of different heights.

15. The hands-free motorized singing bowl arrangement of claim 13, wherein:
said base structure comprises two curved shoulder portions disposed opposite said arm structure and configured to cradle or substantially follow a curved outer surface of a singing bowl; and
said base structure comprises a telescoping section disposed between said securing bolt and said two curved shoulder portions and configured to permit adjustment of the horizontal position of said two curved shoulder portions to permit a user to increase or decrease the space between said arm structure and said two curved shoulder portions to accommodate singing bowls of different widths.

16. The hands-free motorized singing bowl arrangement of claim 1, further comprising a control processor disposed in said head structure wherein said control processor is operatively connected to said motor to control the operation thereof.

17. The hands-free motorized singing bowl arrangement of claim 16, further comprising a digital control screen and/or manual control buttons mounted in said head structure and configured to permit a user to view operating settings and/or select operating settings comprising actuation of said motor, speed of rotation of said motor, and duration of rotation of said axle in accordance with a preset program or user-selected settings.

18. The hands-free motorized singing bowl arrangement of claim 16, further comprising a transceiver configured to receive input commands wirelessly from an app on a mobile device or a remote control.

19. The hands-free motorized singing bowl arrangement of claim 1, further comprising an LED light arrangement disposed in at least one of said head structure, said arm structure, and said base structure and configured to emit aesthetic and/or multi-colored lights.

20. The hands-free motorized singing bowl arrangement of claim 1, wherein:
said mallet is removably attached to said telescopic arm to permit replacement or exchanging of said mallet with another mallet of a different size or material; and
said mallet comprises a contact layer configured to contact a rim portion of a singing bowl and comprising rubber, leather, or silicone material; and
said base structure comprises a rear cradle configured to hold said mallet and/or additional mallets and/or an instruction manual.
